(19) United States
(12) Patent Application Publication
(10) Pub. No.: US 2018/0339889 A1
(43) Pub. Date: Nov. 29, 2018

(54) MOBILE CRANE FOR ANGLING A MAIN JIB EXTENSION RELATIVE TO A MAIN JIB OF A MOBILE CRANE

(71) Applicant: Terex Global GmbH, Schaffhausen (CH)

(72) Inventors: Roland Kuhn, St. Ingbert (DE); Michael Martin, Illingen (DE)

(21) Appl. No.: 15/778,432

(22) PCT Filed: Nov. 22, 2016
(86) PCT No.: PCT/EP2016/078461

§ 371 Date: May 23, 2018

(30) Foreign Application Priority Data
Nov. 24, 2015 (DE) 10 2015 120 350.2

(51) Int. Cl. B66C 23/70; B66C 23/06; B66C 23/42; B66C 23/68; B66C 23/82

(52) U.S. Cl. CPC B66C 23/702; B66C 23/06; B66C 23/82; B66C 23/68; B66C 23/42

(57) ABSTRACT

A mobile crane having a tiltably mounted main jibwhich can be erected by a tilting cylinder, and having a main jib extension releasably connected to a main jib head of the main jib by upper and lower bolts. Starting from a normal position, after release of the upper bolts, the main jib extension can be angled about a tilting axis relative to the main jib by an angling drive that engages on a foot of the main jib extension, and a drive that is provided for another purpose supplies the kinetic energy for the angling drive. The angling drive includes a lever element having two lever arms, pivotably mounted on the upper chord of the main jib extension, with the first lever arm being connected to a lifting cable of the lifting gear for operation of the angling drive and engaging the main jib head by the second lever arm.

### CROSS REFERENCE TO RELATED APPLICATIONS

The present application claims the priority benefits of International Patent Application No. PCT/EP2016/078461, filed Nov. 22, 2016, and claims benefit of German patent applicaiton DE 10 2015 120 350.2, filed Nov. 24, 2015.

### BACKGROUND OF THE INVENTION

The invention relates to a mobile crane with a main jib luffably mounted thereon and able to be raised via a luffing cylinder, and with a main jib extension releasably connected to a main jib head of the main jib via upper bolts and lower bolts, the main jib extension, starting from a basic position after release of the upper bolts, is able to be angled about a luffing axis relative to the main jib by means of an angling drive, the angling drive engages on a foot of the main jib extension, wherein a lifting mechanism of the mobile crane, which is provided for another task, provides the movement energy for the angling drive.

The invention also relates to a method for angling a main jib extension relative to a main jib of a mobile crane, wherein the main jib is luffably mounted on the mobile crane and can be raised via a luffing cylinder, the main jib extension is releasably connected to a main jib head of the main jib via upper bolts and lower bolts and an angling drive engages on a foot of the main jib extension.

German utility model DE 20 2004 020 760 U1 already discloses a mobile crane with a main jib and a main jib extension fastened to its main jib head. The main jib extension is luffable from a basic position, in which the main jib extension is oriented with its longitudinal direction as an extension of the longitudinal direction of the main jib, into a 20° position and a 40° position. In a conventional manner, the main jib extension is releasably fastened to the main jib head via two lower bolts disposed in the region of bottom chords of the main jib extension and two upper bolts disposed in the region of top chords of the main jib extension. In order to be able to luff the main jib extension about the two lower bolts serving as a luffing axis out of the basic position, in a first step the two upper bolts are pulled and in a second step, by means of hydraulic luffing cylinders which engage on the main jib head and on the main jib extension, the luffing of the main jib extension is effected. The insertion and pulling of the two upper bolts is effected in each case via a hydraulic bolting cylinder. In order to power the luffing cylinders and the bolting cylinders an autonomous hydraulic assembly is disposed at the lower end of the main jib extension. It is possible to use e.g. a diesel engine or an electric motor, in each case with an associated hydraulic pump, as the hydraulic assembly.

German patent specification DD 291 531 A5 relates to a mobile crane with an angling plate between a main jib and a main jib extension, wherein the main jib extension, starting from a basic position after release of a holding bolt, can be angled by means of an angling drive about a luffing axis. The movement energy required for this is supplied by a lifting cable of the mobile crane.

A mobile crane with a main jib is also known from the German laid-open document DE 10 2009 010 452 A1. A lifting cable is inter alia used to mount and dismount a main jib extension to/from the main jib.

### SUMMARY OF THE INVENTION

The present invention provides a mobile crane and a method for angling a main jib extension relative to a main jib of a mobile crane, with which the angling of the main jib extension is simplified.

In accordance with the invention, in the case of a mobile crane with a main jib luffably mounted thereon and able to be raised via a luffing cylinder, and with a main jib extension releasably connected to a main jib head of the main jib via upper bolts and lower bolts, wherein the main jib extension, starting from a basic position after release of the upper bolts, is able to be angled about a luffing axis relative to the main jib by means of an angling drive, the angling drive engages on a foot of the main jib extension, wherein a lifting mechanism of the mobile crane, which is provided for another task, provides the movement energy for the angling drive, a simplification is achieved by virtue of the fact that the angling drive comprises a lever element having two lever arms, the lever element is pivotably mounted on the top chord of the main jib extension, the first lever arm is connected to a lifting cable of the lifting mechanism for operating the angling drive and engages on the main jib head via the second lever arm. This ensures that the angling procedure is not performed by means of external auxiliary means or additional auxiliary cylinders but instead lifting mechanisms are used which are provided on the mobile crane and are already present. The angling procedure is not performed by means of hydraulic cylinders which are to be additionally provided. The angling per se takes place predominantly on the ground or the deposit position of the main jib so that it is not necessary to work far above the upper edge of the mobile crane. The invention makes it possible to angle the main jib extension in the case of a mobile crane standing on even ground and with a horizontally oriented telescopic jib. The last part of the luffing-up of the main jib extension into a 20° or a 40° position is assisted by the luffing cylinder of the main jib. Provision is made that the angling drive is formed such that a lifting mechanism of the mobile crane provides the movement energy for the angling drive. The lever arm is arranged centrally, as seen from above the main jib extension. In this manner, it is not necessary to provide a fork head offset, which compensates for a deformation of the main jib extension, between the main jib and main jib extension. This is particularly important in the case of long narrow jib systems. Also for this reason no auxiliary cylinder is required by means of which a fork head offset has to be compensated for. The moment required for angling is in this case preferably generated via a combination of lifting cable force and a smaller lifting arm together with a force deflection, so that a higher force for angling is available compared with a variant having a long lever arm.

A force increase is achieved by virtue of the fact that the first lever arm is longer than the second lever arm.

Provision is advantageously made that in particular the angling drive engages the main jib on the one hand and engages the main jib extension in the region of its top chord on the other hand. Moreover, the angling drive is advantageously designed in such a way that the main jib extension can be raised and lowered so as to pivot about the luffing axis against the effect of the gravitational force of the main jib extension. In particular, in this case the luffing axis is formed by a lower rolling head spindle.

In association with the present invention, a mobile crane is understood to be both a movable telescopic crane and also a movable crawler crane with a lattice mast jib.

The invention is explained in more detail hereinunder with the aid of an exemplified embodiment illustrated in the drawings.

### BRIEF DESCRIPTION OF THE DRAWINGS

FIG. 1 shows a side view of a main jib with a main jib extension in a basic position;

FIG. 2 shows a detailed, partially sectional view of FIG. 1 from the region where the main jib extension is coupled onto the main jib;

FIG. 3 shows a plan view of FIG. 2;

FIG. 4a shows a side view of an angling plate in a 40° position;

FIG. 4b shows a sectional view of FIG. 4a;

FIG. 4c shows a plan view of an angling plate in a transport position;

FIG. 4d shows a sectional view of FIG. 4c;

FIG. 4e shows a side view of an angling plate in a 20° position;

FIG. 5 shows the main jib of FIG. 1 with the main jib extension in a 15° position;

FIG. 6 shows a detailed, partially sectional view of FIG. 5 from the region where the main jib extension is coupled onto the main jib;

FIG. 7 shows a view as in FIG. 6 with a lever element in the transport position;

FIG. 8 shows the main jib of FIG. 1 with the main jib extension in a 40° position; and

FIG. 9 shows a detailed view of FIG. 8 with an angling plate in a stop position.

### DESCRIPTION OF THE PREFERRED EMBODIMENTS

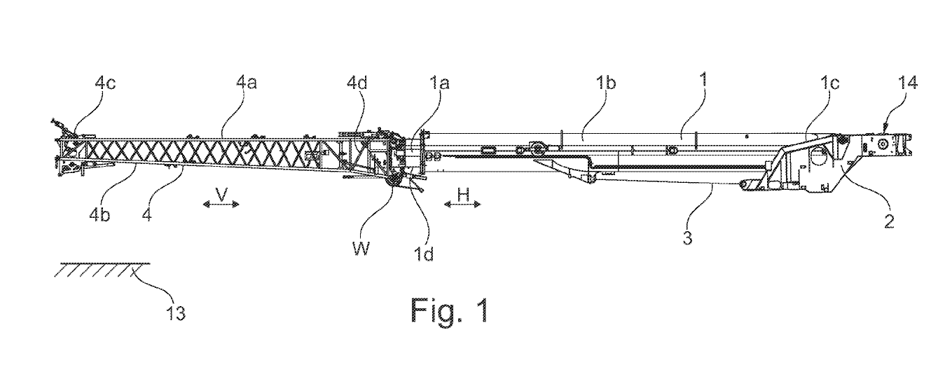

FIG. 1 shows a side view of a main jib 1 of a telescopic crane, not illustrated. Only a base frame 2 of a superstructure of the telescopic crane is illustrated, in which a lifting mechanism 14 is indicated. On the base frame 2, the main jib 1 with its main jib foot 1c is typically mounted so as to be able to pivot about a substantially horizontal axis and can be correspondingly erected and luffed by means of a luffing cylinder 3 which is indicated symbolically by a line and engages on the base frame and on the main jib 1. FIG. 1 shows the main jib 1 in a so-called stored position in which the main jib 1 is oriented with its longitudinal direction substantially horizontal. The main jib 1 is designed as a telescopic jib comprising a basic box 1b and telescopic sections 1d guided therein and has, a main jib head 1b on its end facing away from the base frame 2 of the superstructure, and therefore on the innermost telescopic section 1d. The telescopic jib can be extended and retracted in a typical manner by means of a telescopic cylinder, not illustrated, arranged in the innermost telescopic section 1d. An extension of the main jib 1 in the form of a main jib extension 4 is releasably fastened to the main jib head 1b. The main jib extension 4 can be used temporarily or continuously with the telescopic crane in order to reach an even greater overall jib length exceeding the greatest jib length of the main jib 1, or even to allow work to be carried out behind the structure edges. This main jib extension 4 is designed as a lattice mast which typically has a truss pipe construction. In FIG. 1, the main jib 1 and the main jib extension 4 are located in a 0° position or basic position in which the longitudinal direction H of the main jib 1 and the longitudinal direction V of the main jib extension 4 are aligned with one another or extend in parallel with one another. A so-called luffing angle a of the main jib 1 relative to the superstructure 2 therefore amounts to 0° in the stored position. The luffing angle a describes the raising of the main jib 1 relative to the superstructure 2. In this basic position, the main jib extension 4 is spaced apart from a ground 13 and is therefore supported by the main jib 1 via a bolt connection on the main jib head 1a.

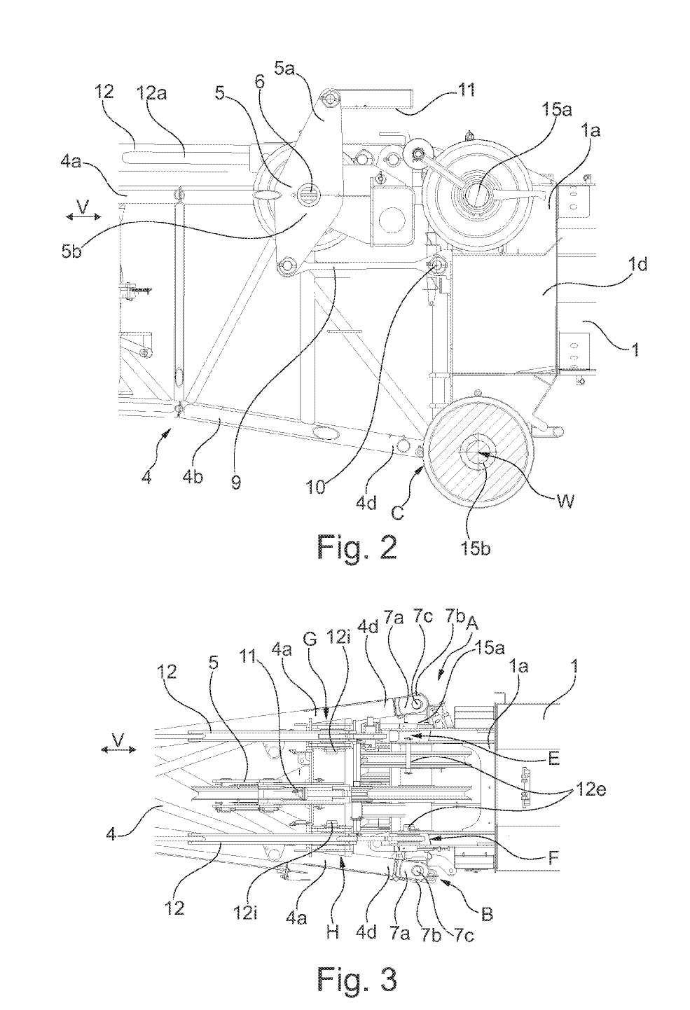

Such main jib extensions 4 are fundamentally constructed as modular design systems from individual main elements and can be fitted together depending on the required length or load capacity thereof. The individual main elements have dimensions suitable for transportation and in most cases are not carried along with the telescopic crane but are transported separately. When the spindle loads of the telescopic crane and the construction size of the main jib extension 4 allow, the main jib extension 4 can be carried along if required. This would then be located in a transport position laterally next to and in parallel with the main jib 1. A connection of the individual main elements to one another to form the desired main jib extension 4 is effected via bolt connections in corresponding bolting points A, B, C and D (see FIG. 2). The attachment to the main jib head 1a can be effected using the main elements or as a preassembled unit or units.

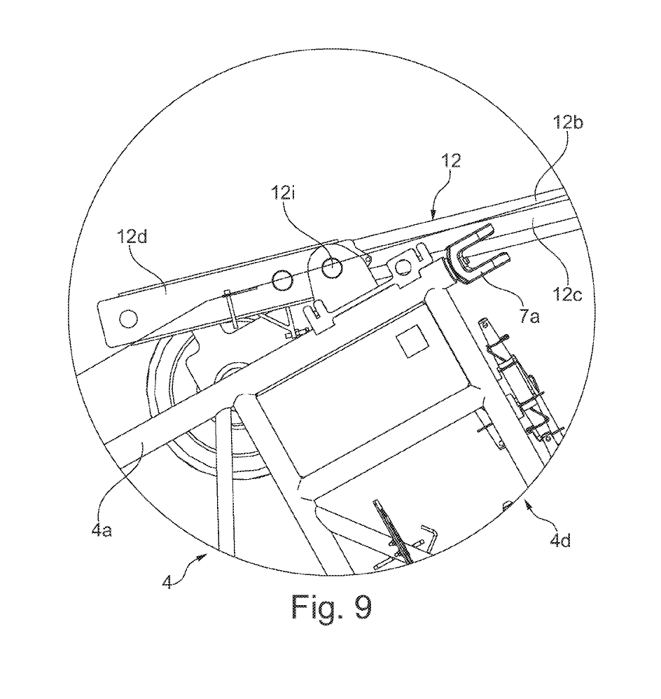

FIG. 2 shows a detailed view of FIG. 1 from the region where the main jib extension 4 is coupled onto the main jib 1. The main jib extension 4 comprising, in a conventional manner, a rectangular cross-section, is fastened via four bolt connections disposed in the corner regions of the main jib extension 4 to bolting points A, B, C and D by means of corresponding bolts 7c on the main jib 1. The bolting points A, B, C and D are in the region of an upper rolling head spindle 15a and lower rolling head spindle 15b which are each arranged on the main jib head 1a. Each of the four bolt connections is designed as a so-called double shear bolt connection which in a corresponding manner is substantially made up of a fork plate 7a, a plate 7b and a bolt 7c (see also FIGS. 3 and 9). The fork plate 7a with its two opposing bores for the bolt 7c is fastened at each of the four bolting points A to D to a foot 4d of the main jib extension 4 and as an extension of the main jib extension 4. In this case the bores in the fork plate 7a are vertically oriented when the main jib extension 1 is horizontal. The plate 7b is fastened to the main jib head 1a via the upper or lower roller head spindle 15a, 15b. Accordingly, the plate 7b is arranged in each case at the ends and as an extension of the upper or lower roller head spindle 15a, 15b. When the main jib head 1a is oriented horizontally, the upper or lower roller head spindle 15a, 15b is oriented horizontally and transversely to the longitudinal direction H of the main jib 1 and is rotatably mounted in the main jib head 1a. In a corresponding manner, the plate 7b is in each case also rotatable about the horizontal upper or lower roller head spindle 15a, 15b. In each case, the plate 7b also comprises a bore which is aligned with the bores of the respective fork plate 7a. A bolt 7c is inserted into each of the bores in the plate 7b and those in the fork plate 7a in order to fasten the main jib extension 4 to the main jib head 1a in a corresponding manner. The lower connecting element consists, like the upper connecting element, of a fork plate, plate and bolt which are not illustrated in the figures for reasons of clarity.

The two upper bolts 7c (see FIG. 3) arranged in the region of a top chord 4a of the main jib extension 4 are oriented with their longitudinal axis vertical when the main jib extension 4 is oriented with its longitudinal direction V horizontal. The two further lower bolts arranged in the region of a bottom chord 4d of the main jib extension 4 are oriented in a corresponding manner. The lower roller head spindle 15b, on which the two lower bolts in the bolting points C and D engage, simultaneously forms a luffing axis W for pivoting of the main jib extension 4 relative to the main jib 1.

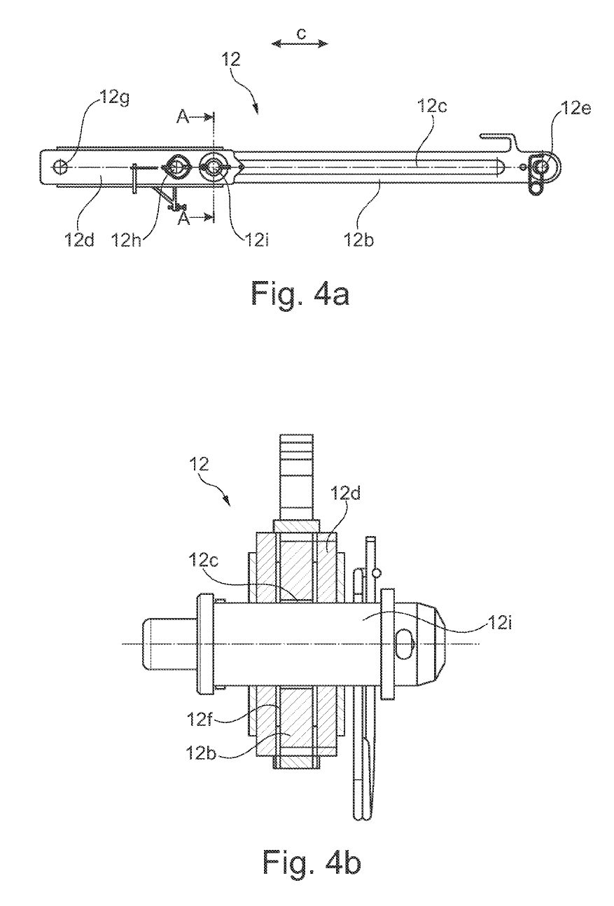

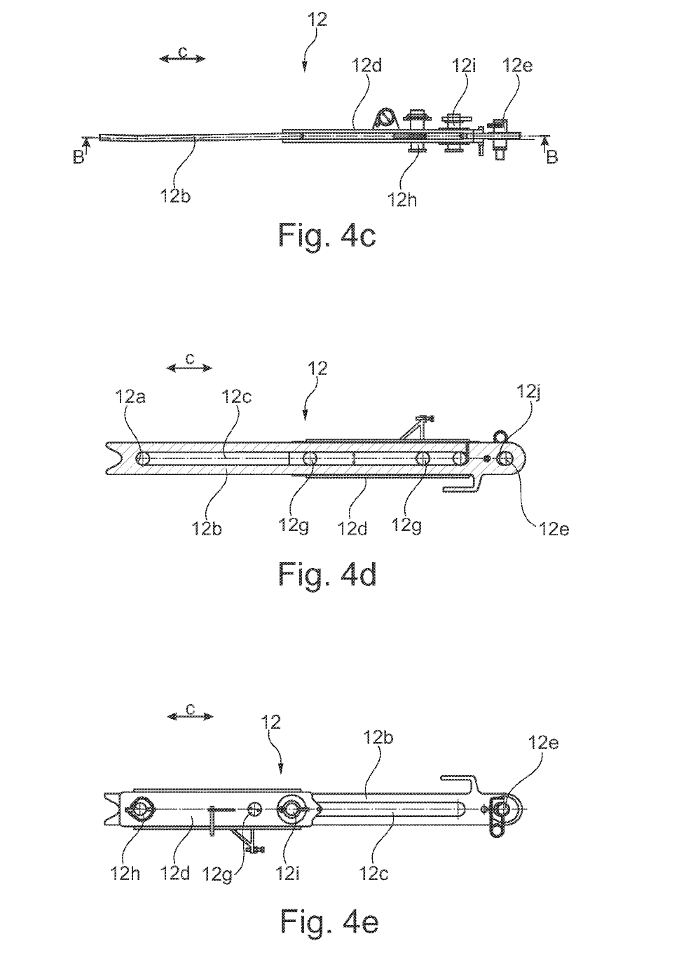

FIG. 2 illustrates the main jib extension 4 in cross-section in order to be able to show a lever element 5 mounted in the centre of the main jib extension 4 as seen from above. The lever element 5 comprises, in the manner of a two-arm lever, a first long lever arm 5a and a second short lever arm 5b and is overall substantially diamond-shaped, wherein the pure diamond shape is distorted corresponding to the long and short lever arm 5a, 5b. Moreover, the lever element 5 is eccentrically mounted so as to be pivotable about a lever spindle 6 which is arranged in the region of a top chord 4a of the main jib extension 4 and is oriented transversely with respect to the longitudinal direction V of the main jib extension 4 and horizontally. A spindle provided for a cable pulley on the main jib extension 4 can be used as the lever spindle 6. The lever element 5 is mounted on the lever spindle 6 such that the long lever arm 5a points obliquely upwards and the short lever arm 5b points obliquely downwards—in each case as seen when the main jib extension 4 is oriented horizontally. The length ratio between the short and long lever arms 5a, 5b is approximately 2:1 and therefore a corresponding power gear ratio or force increase is provided. The lower end of the short lever arm 5b pointing away from the lever spindle 6 and in the direction of a tip 4c of the main jib extension 4 is connected in a hinged manner to a pull rod 9 whose opposite end is articulated on the main jib head 1a in a hinged manner at a bolting point 10. The pull rod 9 extends with its longitudinal extension approximately in the longitudinal direction V of the main jib extension 4 and the bolts thereof for fastening to the lever element 5 and the main jib head 1a extend in parallel with the lever spindle 6. At the upper end of the long lever arm 5a pointing away from the lever spindle 6 and in the direction of a foot 4d of the main jib extension 4, a lifting cable 11 originating from a lifting mechanism 14 on the superstructure 2 can be connected in a hinged manner as required. Moreover, in the region of the top chord 4a next to the coupling via the two upper bolts 7c laterally on the top chord 4a in each case a so-called angling plate 12 is arranged, which angling plates are connected at one end to the main jib head 1 a in each case in bolting points E and F and are connected in a central region to the top chord 4a of the main jib extension 4 in bolting points G and H. By means of the angling plate 12, it is possible—after releasing the two upper bolts 7c—to permit angling of the main jib extension 4 relative to the main jib 1 and about the luffing axis W or to limit said angling to a preselected position. Preferably, starting from the basic position or 0° position of an angling angle b, the main jib extension 4 is moved into a 20° position or 40° position. The angling angle b is formed by the longitudinal direction H of the main jib 1 and the longitudinal direction V of the main jib extension 4 (see FIG. 4). For this purpose, each of the two angling plates 12 is fastened at one end to the main jib head 1a in a hinged manner via horizontally extending connecting bolts 12e and each has at the other end a stop opening 12c whose longitudinal extension extends substantially in parallel with the longitudinal direction V of the main jib extension 4. The angling plate 12 is connected to the main jib extension 4 via a further connecting bolt 12i which extends transversely through the stop opening 12c. The maximum possible angling of the main jib extension 4—which corresponds to an angling angle b of 40° in the present case—can be set over the selected length of the stop opening 12c. By manually and mechanically limiting the length of the stop opening 12c, angling of the main jib extension 4 with respect to the main jib 1 can be set in stages in preselected angles. In the present case, this occurs for a 20° position.

Instead of the lower and upper roller head spindles 15a, 15b provided with this construction of the main jib 1, spindles additionally provided for the attachment of the main jib extension 4 and being oriented and rotatable corresponding to the above-described roller head spindle 9a could also be provided on the main jib head 1a. The plates 7b can also be fastened to the main jib head 1a directly and therefore in a non-rotatable manner. In order to achieve the luffability of the main jib extension 4 relative to the main jib 1, the bore for one of the bolts 7c in the plate 7b must then be oriented horizontally in each case.

FIG. 3 shows a plan view of FIG. 2. It can be seen that the two angling plates 12 extend in the region of the long sides of the top chord 4a of the main jib extension 4 and in parallel with each other. The two upper bolts 7c are also shown in the bolting points A and B, by means of which the main jib extension 4 is attached to the main jib head 1a.

FIG. 4a shows a side view of an angling plate 12 in a maximally extended 40° position. The angling plate 12, by means of which a displacement path and therefore the angling angle b can be manually limited by means of a stop surface 12a (see FIG. 4d), consists substantially of a sliding plate 12b having a long hole-shaped guiding opening 12c, at which a guiding plate 12d can be guided in the longitudinal direction c of the sliding plate 12b. The sliding plate 12b is designed as an elongated flat profile having the stop opening 12c and extends substantially in parallel with the longitudinal direction v of the main jib extension 1. At an end facing the main jib head 1a, the sliding plate 12b has a bore 12j (see FIG. 4d), via which the sliding plate 12b is releasably fastened to the main jib head 1a at one of the bolting points E and F in each case by means of a connecting bolt 12e. The connecting bolt 12e is oriented with its longitudinal extension in parallel with the upper or lower rolling head spindle 15a, 15b. Slid onto the sliding plate 12b is the guiding plate 12d which for this purpose has a closed rectangular cross-section with a guiding opening 12f (see FIG. 4b), into which the sliding plate 12b is inserted and displaceably guided. The guiding plate 12d per se is releasably fastened to the main jib extension 4 at an end facing the main jib head 1a by means of in each case a further connecting bolt 12i at one of the bolting points G and H. The connecting bolt 12i is oriented with its longitudinal extension in parallel with the upper or lower rolling head spindle 15a, 15b. In this case, the connecting bolt 12i is also guided through the stop opening 12c of the sliding plate 12b. In order to limit a displacement of the guiding plate 12d on the sliding plate 12b, two stop bores 12g (see FIG. 4d) which are continuous and spaced apart from one another in the longitudinal direction of the guiding plate 12d are arranged in the side parts of the guiding plate 12d. A first one of the two stop bores 12g serves to limit the angling angle b to 20° and a second one of said stop bores serves to limit said angling angle to 40°. The stop bores 12g for 40° are accordingly arranged closer to the main jib head 1 in order to permit a larger displacement path. Depending upon the desired angling angle b, the respective stop bore 12g has a stop bolt 12h inserted therein which then extends through the two opposite stop bores 12g and the stop opening 12c located therebetween. In FIG. 4a, the connecting bolt 12h is inserted into the second one of the two stop bores 12g which limits the angling angle b to 40°. The stop bolt 12h is guided next to the bolt 12i in the stop opening 12c. The bolt 12i would only come into contact with the opposite stop surface 12a of the stop opening 12c if no stop bolt 12h is inserted. The second one of the two stop bores 12g is free.

FIG. 4b illustrates a sectional view of FIG. 4a taken along section line A-A. It can be seen that the guiding plate 12d has a rectangular cross-section having a central guiding opening 12f, in which the sliding plate 12b with its stop opening 12c is guided.

FIG. 4c also illustrates a plan view of an angling plate 12 in a transport position. In this transport position, the angling plate 12 is not fastened to the main jib head 1a by means of the connecting bolt 12e and the sliding plate 12b is inserted in the direction of the main jib extension 4 into the guiding plate 12d. The connecting bolt 12e and the stop bolt 12h are inserted for storage purposes.

FIG. 4d shows a sectional view of FIG. 4c taken along section line B-B in FIG. 4c. This view clearly shows the stop opening 12c and the two stop bores.

FIG. 4e illustrates a side view of an angling plate 12 which corresponds substantially to the angling plate 12 shown in FIG. 4a. Unlike in FIG. 4a, the angling plate 12 is not illustrated in the 40° position but instead is illustrated in the 20° position. Accordingly, the stop bolt 12h is inserted in the stop bore 12g remote from the main jib head 1a.

Angling of the main jib extension 4—located in the basic position as per FIG. 1—into a 40° position will be explained hereinunder. In a first step, the lifting cable 11 is connected from the lifting mechanism 14 to the upper long lever arm 5a of the lever element 5 (see FIG. 2). Then, the lifting cable 11 is tightened or wound up from the lifting mechanism 14 on the superstructure 2 until the main jib extension 4 is raised slightly via the lever element 5 mounted in the region of the top chord 4a of the main jib extension 4 and supported on the main jib head 1a, so that the upper bolts 7c on the top chord 4a of the main jib extension 4 are unburdened. The now unburdened bolts 7c are then removed. The main jib extension 4 is now supported via the lower bolts in combination with the lifting cable 11 on the main jib 1. The two angling plates 12 which are already fastened to the main jib extension 4 via the connecting bolts 12i are already previously connected to the main jib head 1a via further connecting bolts 12e, or are connected at the latest at the present time. The now desired maximum displacement path is also set at the angling plates 12 in order to permit or limit the angling of the main jib extension 4 to the 20° or 40° position. For the 40° position, the maximum angling is limited and thus the maximum extending of the angling plate 12 is effected by the insertion of the stop bolt 12h in the stop bore 12g closer to the connecting bolt 12i and the length of the stop opening 12c in the sliding plate 12b of the angling plate 12. In a subsequent step, the lifting cable 11 is released and in so doing the lever element 5 rotates about the lever spindle 6, the main jib extension 4 pivots about the luffing axis W and is lowered until its tip 4a contacts the ground 13.

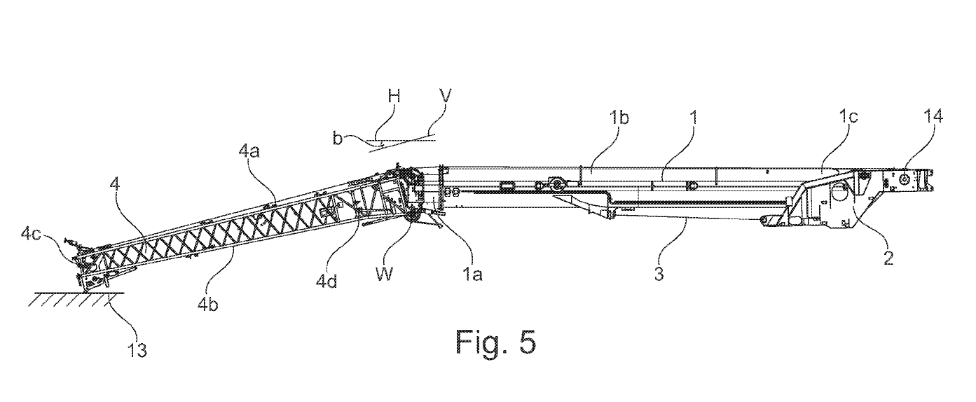

FIG. 5, which shows the main jib 1 according to FIG. 1 with the main jib extension 4 in a 15° position, shows the position described above in which the lowered tip 4a is supported on the ground 13.

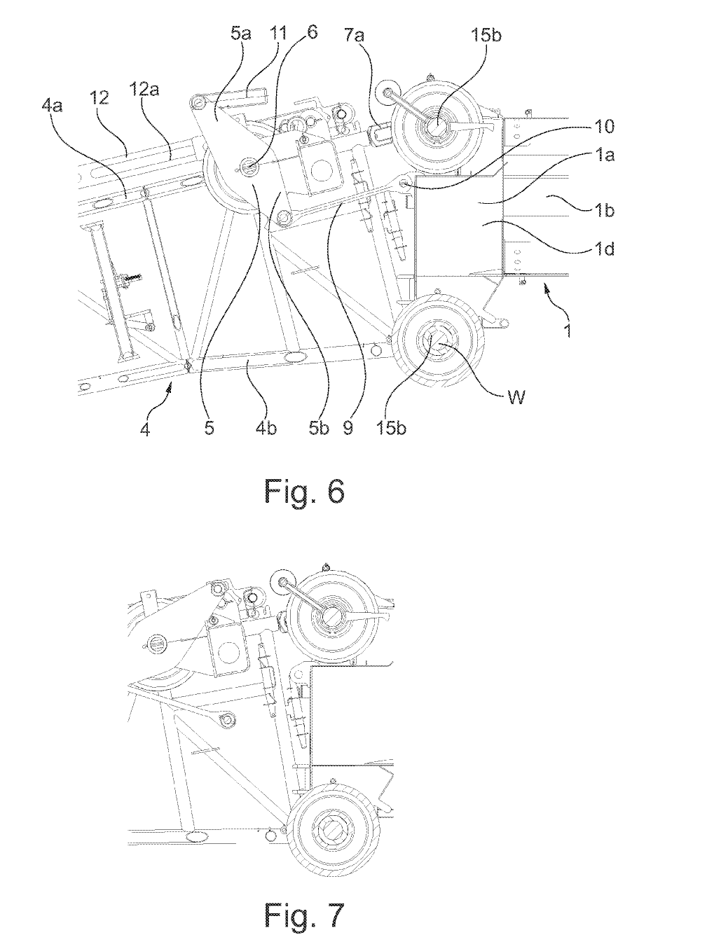

FIG. 6 shows a detailed, partially sectional view of FIG. 5 from the region where the main jib extension 4 is coupled onto the main jib 1. This Figure shows that the main jib extension 4 is held in the angled position via the luffing axis W with the lower bolts and by the pull rod 9 together with the lever element 5 on the main jib head 1a. The upper bolts 7c are pulled and the upper fork plates 7a in the region of the top chord 4a are free. The lifting cable 11 is just indicated. Also, the sliding plates 12 are not fastened to the main jib head 1a in order to more clearly show the upper fork plates 7a. The sliding plates 12 are to be fastened, at the latest at the present time, to the main jib head 1a via the connecting bolts 12e at the bolting points E and F.

Now, because the tip 4c is resting on the ground 13 and the lifting cable 11 is unburdened, the pull rod 9 is released from the main jib head 1a and the lever element 5 is pivoted together with the pull rod 9 into a transport position. This transport position is shown in FIG. 6 which shows a view corresponding to FIG. 5 with a changed position of the lever element 5 in the transport position. In the transport position, the short and long lever arm 5a, 5b are oriented more in parallel with the longitudinal direction V of the main jib extension 4.

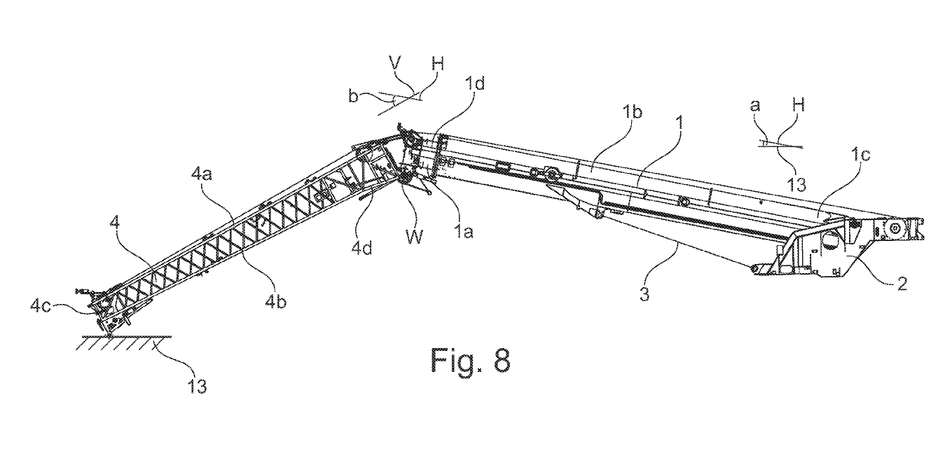

In a further step, by luffing-up the main jib 1, the main jib extension 4 is angled further and the tip 4c of the main jib extension 4 slides therethrough over the ground 13 in the direction of the superstructure 2. By means of the luffing-up action, the main jib extension 4 is angled further to a luffing angle a, which is formed by the longitudinal direction H of the main jib 1 and the horizontal of the ground 13, for as long as until the angling plates 12 limit the angling in a preselected position. This position, in which the main jib extension 4 is located in a 40° position relative to the main jib 1, is illustrated in FIG. 8. At the point in time the angling movement is limited by the angling plates 12, the tip 4c is still just about in contact with the ground 13. During further luffing-up of the main jib 1, the main jib extension 4 then lifts from the ground 13 until the desired position for the main jib 1 with the main jib extension 4 arranged thereon in a 40° position with respect thereto is reached. In this position, the main jib extension 4 is held by its empty weight. However, corresponding locking in the angling plates 12 may not be provided in the present embodiment.

Angling back the main jib extension 4 takes place in the reverse order.

FIG. 9 shows a detailed view of FIG. 8 from the region where the main jib extension 4 is coupled onto the main jib 1 with an angling plate 12 in a stop position with respect to a desired maximum angling position.

Although in conjunction with the present exemplified embodiment, the main jib 1 is described as a telescopic jib and the main jib extension 4 is described as a lattice mast jib, the invention can also be applied to other embodiments of the main jib 1 and main jib extension 4. The main jib 1 can also be a lattice mast jib or a combination of a telescopic jib, lattice mast jib and/or box jib. For the main jib extension 4, lattice mast jibs or box jibs or combinations thereof are feasible.

1. A mobile crane, said mobile crane comprising a luffably mounted main jib that is configured to be raised via a luffing cylinder, and with a main jib extension releasably connected to a main jib head of the main jib via upper bolts and lower bolts, wherein the main jib extension, starting from a basic position after release of the upper bolts, is able to be angled about a luffing axis relative to the main jib by an angling drive, wherein the angling drive engages on a foot of the main jib extension, and wherein a lifting mechanism of the mobile crane, which is provided for another task, provides the movement energy for the angling drive, wherein the angling drive comprises a lever element having two lever arms with the lever element pivotably mounted on the top chord of the main jib extension, and wherein the first lever arm is connected to a lifting cable of the lifting mechanism for operating the angling drive and engages on the main jib head via the second lever arm.

2. The mobile crane as claimed in claim 1, wherein the first lever arm is longer than the second lever arm so as to achieve a force increase.

3. The mobile crane as claimed in claim 2, wherein the angling drive engages the main jib on the one hand and engages the main jib extension in the region of its top chord on the other hand.

4. The mobile crane as claimed in claim 3, wherein the angling drive is configured such that the main jib extension can be raised and lowered in a pivoting manner about the luffing axis against the effect of the gravitational force of the main jib extension.

5. The mobile crane as claimed in claim 4, wherein the luffing axis is formed by a lower rolling head spindle.

6. The mobile crane as claimed in claim 2, wherein the angling drive is configured such that the main jib extension can be raised and lowered in a pivoting manner about the luffing axis against the effect of the gravitational force of the main jib extension.

7. The mobile crane as claimed in claim 6, wherein the luffing axis is formed by a lower rolling head spindle.

8. The mobile crane as claimed in claim 1, wherein the angling drive engages the main jib on the one hand and engages the main jib extension in the region of its top chord on the other hand.

9. The mobile crane as claimed in claim 8, wherein the angling drive is configured such that the main jib extension can be raised and lowered in a pivoting manner about the luffing axis against the effect of the gravitational force of the main jib extension.

10. The mobile crane as claimed in claim 8, wherein the luffing axis is formed by a lower rolling head spindle.

11. The mobile crane as claimed in claim 1, wherein the angling drive is configured such that the main jib extension can be raised and lowered in a pivoting manner about the luffing axis against the effect of the gravitational force of the main jib extension.

12. The mobile crane as claimed in claim 11, wherein the luffing axis is formed by a lower rolling head spindle.

13. The mobile crane as claimed in claim 1, wherein the luffing axis is formed by a lower rolling head spindle.

14. The mobile crane as claimed in claim 2, wherein the luffing axis is formed by a lower rolling head spindle.
